(19) United States
(12) Patent Application Publication
(10) Pub. No.: US 2025/0286660 A1
(43) Pub. Date: Sep. 11, 2025

(54) DEVICES, METHODS, APPARATUSES, AND COMPUTER READABLE MEDIA FOR MEDIUM ACCESS CONTROL-CONTROL ELEMENT TRANSMISSION

(71) Applicant: Nokia Technologies Oy, Espoo (FI)

(72) Inventors: Pingping WEN, Shanghai (CN); Ping YUAN, Beijing (CN); Chunli WU, Beijing (CN)

(21) Appl. No.: 18/854,648

(22) PCT Filed: Apr. 8, 2022
(86) PCT No.: PCT/CN2022/085768

§ 371 Date: Oct. 7, 2024

(51) Int. Cl. H04L 1/1812; H04L 1/1607; H04W 80/02

(52) U.S. Cl. CPC H04L 1/1812; H04L 1/1614; H04W 80/02

(57) ABSTRACT

Disclosed are devices, methods, apparatuses, and computer readable media for medium access control-control element transmission. An example terminal device may include at least one processor and at least one memory. The at least one memory may include computer program code, and the at least one memory and the computer program code may be configured to, with the at least one processor, cause the terminal device to perform: obtaining, a transmission number configured by a network device for sending an uplink medium access control-control element; and sending, to the network device, the uplink medium access control-control element in a hybrid automatic repeat request process if a number of transmission is less than the configured transmission number, in response to a trigger event for the uplink medium access control-control element.

### TECHNICAL FIELD

Various embodiments relate to devices, methods, apparatuses, and computer readable media for medium access control-control element (MAC-CE) transmission.

### BACKGROUND

In a non-terrestrial network (NTN), for uplink (UL), two UL hybrid automatic repeat request (HARQ) retransmission states/modes are defined: HARQ mode A and HARQ mode B. UE behavior in the HARQ mode A best supports reception of UL retransmission grant based on UL decoding result. For example, in the HARQ mode A, the HARQ retransmission may be scheduled by network side based on the HARQ transmission decoding result. UE behavior in the HARQ mode B best supports no UL retransmission and/or blind UL retransmission. For example, in the HARQ mode B, the HARQ retransmission may be scheduled before the network side achieving the HARQ transmission decoding result. When a MAC-CE is multiplexed/transmitted, the trigger event for the MAC-CE will be cancelled. If the MAC-CE is multiplexed in the HARQ mode B, no UL retransmission and/or blind UL retransmission cannot ensure the MAC-CE can be decoded correctly. If the MAC-CE is critical and cannot be decoded by a base station (BS) successfully, system performance will be impacted. On the other hand, if the MAC-CE is limited to be multiplexed in the HARQ mode A, the MAC-CE transmission opportunity is also limited, which may cause transmission latency.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may include computer program code, and the at least one memory and the computer program code may be configured to, with the at least one processor, cause the terminal device to perform: obtaining, a transmission number configured by a network device for sending an uplink medium access control-control element: and sending, to the network device, the uplink medium access control-control element in a hybrid automatic repeat request process if a number of transmission is less than the configured transmission number, in response to a trigger event for the uplink medium access control-control element.

In some example embodiments, the at least one memory and the computer program code may be further configured to, with the at least one processor, cause the terminal device to further perform: cancelling the trigger event if the uplink medium access control-control element is sent in the hybrid automatic repeat request process of mode A: and refraining from further sending the uplink medium access control-control element.

In some example embodiments, the at least one memory and the computer program code may be further configured to, with the at least one processor, cause the terminal device to further perform: cancelling the trigger event if receiving, from the network device, a downlink medium access control-control element acknowledging decoding of the uplink medium access control-control element: and refraining from further sending the uplink medium access control-control element.

In some example embodiments, the acknowledging downlink medium access control-control element may have a logical channel identifier or an extended logical channel identifier specific for the acknowledgment of the decoding of the uplink medium access control-control element.

In some example embodiments, the logical channel identifier or the extended logical channel identifier may be in a subheader of the acknowledging downlink medium access control-control element, and the acknowledging downlink medium access control-control element may be without a payload.

In some example embodiments, the downlink medium access control-control element may have a reserved bit specific for the acknowledgment of the decoding of the uplink medium access control-control element.

In some example embodiments, the acknowledging downlink medium access control-control element may have a payload indicating the acknowledgment of decoding the uplink medium access control-control element by a bitmap.

In some example embodiments, the at least one memory and the computer program code may be further configured to, with the at least one processor, cause the terminal device to further perform: cancelling the trigger event if the number of transmission reaches the configured transmission number.

In some example embodiments, the number of transmission may be counted based on a number of initial transmission and retransmission of at least one transport block carrying the uplink medium access control-control element.

In some example embodiments, the number of transmission may be counted based on a number of initial transmission of at least one transport block carrying the uplink medium access control-control element.

In some example embodiments, the at least one memory and the computer program code may be further configured to, with the at least one processor, cause the terminal device to further perform: starting a timer configured by the network device for retriggering the trigger event, and retriggering the trigger event upon expiry of the timer if the number of transmission reaches the configured transmission number and without receiving, from the network device, a downlink medium access control-control element acknowledging the decoding of the uplink medium access control-control element before the timer expires.

In some example embodiments, the timer may be started at a last retransmission of the uplink medium access control-control element.

In some example embodiments, the timer may be started at an initial transmission of the uplink medium access control-control element.

In some example embodiments, the uplink medium access control-control element may be sent in the hybrid automatic repeat request process of mode B.

In some example embodiments, the transmission number may be common for a plurality of uplink medium access control-control elements.

In some example embodiments, the transmission number may be specific to the uplink medium access control-control element.

In a second aspect, disclosed is a network device. The network device may include at least one processor and at least one memory. The at least one memory may include computer program code, and the at least one memory and the computer program code may be configured to, with the at least one processor, cause the network device to perform: configuring a transmission number for a terminal device to send an uplink medium access control-control element, wherein the uplink medium access control-control element may be sent to the network device in a hybrid automatic repeat request process if a number of transmission is less than the configured transmission number, in response to a trigger event for the uplink medium access control-control element.

In some example embodiments, the at least one memory and the computer program code may be further configured to, with the at least one processor, cause the network device to further perform: transmitting, to the terminal device, a downlink medium access control-control element for acknowledging decoding of the uplink medium access control-control element if decoding the uplink medium access control-control element successfully.

In some example embodiments, the at least one memory and the computer program code may be further configured to, with the at least one processor, cause the network device to further perform: configuring the downlink medium access control-control element.

In some example embodiments, the at least one memory and the computer program code may be further configured to, with the at least one processor, cause the network device to further perform: configuring a timer for the terminal device to retrigger the trigger event, the trigger event being retriggered upon expiry of the timer if the number of transmission reaches the transmission number and the terminal device without receiving, from the network device, the downlink medium access control-control element acknowledging the decoding of the uplink medium access control-control element before the timer expires.

In a third aspect, disclosed is a method performed by a terminal device. The method may comprise: obtaining, a transmission number configured by a network device for sending an uplink medium access control-control element: and sending, to the network device, the uplink medium access control-control element in a hybrid automatic repeat request process if a number of transmission is less than the configured transmission number, in response to a trigger event for the uplink medium access control-control element.

In some example embodiments, the method may further comprise: cancelling the trigger event if the uplink medium access control-control element is sent in the hybrid automatic repeat request process of mode A: and refraining from further sending the uplink medium access control-control element.

In some example embodiments, the method may further comprise: cancelling the trigger event if receiving, from the network device, a downlink medium access control-control element acknowledging decoding of the uplink medium access control-control element; and refraining from further sending the uplink medium access control-control element.

In some example embodiments, the acknowledging downlink medium access control-control element may have a logical channel identifier or an extended logical channel identifier specific for the acknowledgment of the decoding of the uplink medium access control-control element.

In some example embodiments, the logical channel identifier or the extended logical channel identifier may be in a subheader of the acknowledging downlink medium access control-control element, and the acknowledging downlink medium access control-control element may be without a payload.

In some example embodiments, the downlink medium access control-control element may have a reserved bit specific for the acknowledgment of the decoding of the uplink medium access control-control element.

In some example embodiments, the acknowledging downlink medium access control-control element may have a payload indicating the acknowledgment of decoding the uplink medium access control-control element by a bitmap.

In some example embodiments, the method may further comprise: cancelling the trigger event if the number of transmission reaches the configured transmission number.

In some example embodiments, the number of transmission may be counted based on a number of initial transmission and retransmission of at least one transport block carrying the uplink medium access control-control element.

In some example embodiments, the number of transmission may be counted based on a number of initial transmission of at least one transport block carrying the uplink medium access control-control element.

In some example embodiments, the method may further comprise: starting a timer configured by the network device for retriggering the trigger event, and retriggering the trigger event upon expiry of the timer if the number of transmission reaches the configured transmission number and without receiving, from the network device, a downlink medium access control-control element acknowledging the decoding of the uplink medium access control-control element before the timer expires.

In some example embodiments, the timer may be started at a last retransmission of the uplink medium access control-control element.

In some example embodiments, the timer may be started at an initial transmission of the uplink medium access control-control element.

In some example embodiments, the uplink medium access control-control element may be sent in the hybrid automatic repeat request process of mode B.

In some example embodiments, the transmission number may be common for a plurality of uplink medium access control-control elements.

In some example embodiments, the transmission number may be specific to the uplink medium access control-control element.

In a fourth aspect, disclosed is a method performed by a network device. The method may comprise: configuring a transmission number for a terminal device to send an uplink medium access control-control element, wherein the uplink medium access control-control element may be sent to the network device in a hybrid automatic repeat request process if a number of transmission is less than the configured transmission number, in response to a trigger event for the uplink medium access control-control element.

In some example embodiments, the method may further comprise: transmitting, to the terminal device, a downlink medium access control-control element for acknowledging decoding of the uplink medium access control-control element if decoding the uplink medium access control-control element successfully.

In some example embodiments, the method may further comprise: configuring the downlink medium access control-control element.

In some example embodiments, the method may further comprise: configuring a timer for the terminal device to retrigger the trigger event, the trigger event being retriggered upon expiry of the timer if the number of transmission reaches the transmission number and the terminal device without receiving, from the network device, the downlink medium access control-control element acknowledging the decoding of the uplink medium access control-control element before the timer expires.

In a fifth aspect, disclosed is an apparatus. The apparatus as a terminal device may comprise: means for obtaining, a transmission number configured by a network device for sending an uplink medium access control-control element: and means for sending, to the network device, the uplink medium access control-control element in a hybrid automatic repeat request process if a number of transmission is less than the configured transmission number, in response to a trigger event for the uplink medium access control-control element.

In some example embodiments, the apparatus may further comprise: means for cancelling the trigger event if the uplink medium access control-control element is sent in the hybrid automatic repeat request process of mode A: and means for refraining from further sending the uplink medium access control-control element.

In some example embodiments, the apparatus may further comprise: means for cancelling the trigger event if receiving, from the network device, a downlink medium access control-control element acknowledging decoding of the uplink medium access control-control element: and means for refraining from further sending the uplink medium access control-control element.

In some example embodiments, the acknowledging downlink medium access control-control element may have a logical channel identifier or an extended logical channel identifier specific for the acknowledgment of the decoding of the uplink medium access control-control element.

In some example embodiments, the logical channel identifier or the extended logical channel identifier may be in a subheader of the acknowledging downlink medium access control-control element, and the acknowledging downlink medium access control-control element may be without a payload.

In some example embodiments, the downlink medium access control-control element may have a reserved bit specific for the acknowledgment of the decoding of the uplink medium access control-control element.

In some example embodiments, the acknowledging downlink medium access control-control element may have a payload indicating the acknowledgment of decoding the uplink medium access control-control element by a bitmap.

In some example embodiments, the apparatus may further comprise: means for cancelling the trigger event if the number of transmission reaches the configured transmission number.

In some example embodiments, the number of transmission may be counted based on a number of initial transmission and retransmission of at least one transport block carrying the uplink medium access control-control element.

In some example embodiments, the number of transmission may be counted based on a number of initial transmission of at least one transport block carrying the uplink medium access control-control element.

In some example embodiments, the apparatus may further comprise: means for starting a timer configured by the network device for retriggering the trigger event, and means for retriggering the trigger event upon expiry of the timer if the number of transmission reaches the configured transmission number and without receiving, from the network device, a downlink medium access control-control element acknowledging the decoding of the uplink medium access control-control element before the timer expires.

In some example embodiments, the timer may be started at a last retransmission of the uplink medium access control-control element.

In some example embodiments, the timer may be started at an initial transmission of the uplink medium access control-control element.

In some example embodiments, the uplink medium access control-control element may be sent in the hybrid automatic repeat request process of mode B.

In some example embodiments, the transmission number may be common for a plurality of uplink medium access control-control elements.

In some example embodiments, the transmission number may be specific to the uplink medium access control-control element.

In a sixth aspect, disclosed is an apparatus. The apparatus as a network device may comprise: means for configuring a transmission number for a terminal device to send an uplink medium access control-control element, wherein the uplink medium access control-control element may be sent to the network device in a hybrid automatic repeat request process if a number of transmission is less than the configured transmission number, in response to a trigger event for the uplink medium access control-control element.

In some example embodiments, the apparatus may further comprise: means for transmitting, to the terminal device, a downlink medium access control-control element for acknowledging decoding of the uplink medium access control-control element if decoding the uplink medium access control-control element successfully.

In some example embodiments, the apparatus may further comprise: means for configuring the downlink medium access control-control element.

In some example embodiments, the apparatus may further comprise: means for configuring a timer for the terminal device to retrigger the trigger event, the trigger event being retriggered upon expiry of the timer if the number of transmission reaches the transmission number and the terminal device without receiving, from the network device, the downlink medium access control-control element acknowledging the decoding of the uplink medium access control-control element before the timer expires.

In a seventh aspect, a computer readable medium is disclosed. The computer readable medium may include instructions stored thereon for causing a terminal device to perform: obtaining, a transmission number configured by a network device for sending an uplink medium access control-control element: and sending, to the network device, the uplink medium access control-control element in a hybrid automatic repeat request process if a number of transmission is less than the configured transmission number, in response to a trigger event for the uplink medium access control-control element.

In some example embodiments, the computer readable medium may further include instructions stored thereon for causing the terminal device to further perform: cancelling the trigger event if the uplink medium access control-control element is sent in the hybrid automatic repeat request process of mode A: and refraining from further sending the uplink medium access control-control element.

In some example embodiments, the computer readable medium may further include instructions stored thereon for causing the terminal device to further perform: cancelling the trigger event if receiving, from the network device, a downlink medium access control-control element acknowledging decoding of the uplink medium access control-control element: and refraining from further sending the uplink medium access control-control element.

In some example embodiments, the acknowledging downlink medium access control-control element may have a logical channel identifier or an extended logical channel identifier specific for the acknowledgment of the decoding of the uplink medium access control-control element.

In some example embodiments, the logical channel identifier or the extended logical channel identifier may be in a subheader of the acknowledging downlink medium access control-control element, and the acknowledging downlink medium access control-control element may be without a payload.

In some example embodiments, the downlink medium access control-control element may have a reserved bit specific for the acknowledgment of the decoding of the uplink medium access control-control element.

In some example embodiments, the acknowledging downlink medium access control-control element may have a payload indicating the acknowledgment of decoding the uplink medium access control-control element by a bitmap.

In some example embodiments, the computer readable medium may further include instructions stored thereon for causing the terminal device to further perform: cancelling the trigger event if the number of transmission reaches the configured transmission number.

In some example embodiments, the number of transmission may be counted based on a number of initial transmission and retransmission of at least one transport block carrying the uplink medium access control-control element.

In some example embodiments, the number of transmission may be counted based on a number of initial transmission of at least one transport block carrying the uplink medium access control-control element.

In some example embodiments, the computer readable medium may further include instructions stored thereon for causing the terminal device to further perform: starting a timer configured by the network device for retriggering the trigger event, and retriggering the trigger event upon expiry of the timer if the number of transmission reaches the configured transmission number and without receiving, from the network device, a downlink medium access control-control element acknowledging the decoding of the uplink medium access control-control element before the timer expires.

In some example embodiments, the timer may be started at a last retransmission of the uplink medium access control-control element.

In some example embodiments, the timer may be started at an initial transmission of the uplink medium access control-control element.

In some example embodiments, the uplink medium access control-control element may be sent in the hybrid automatic repeat request process of mode B.

In some example embodiments, the transmission number may be common for a plurality of uplink medium access control-control elements.

In some example embodiments, the transmission number may be specific to the uplink medium access control-control element.

In an eighth aspect, a computer readable medium is disclosed. The computer readable medium may include instructions stored thereon for causing a network device to perform: configuring a transmission number for a terminal device to send an uplink medium access control-control element, wherein the uplink medium access control-control element may be sent to the network device in a hybrid automatic repeat request process if a number of transmission is less than the configured transmission number, in response to a trigger event for the uplink medium access control-control element.

In some example embodiments, the computer readable medium may further include instructions stored thereon for causing the network device to further perform: transmitting, to the terminal device, a downlink medium access control-control element for acknowledging decoding of the uplink medium access control-control element if decoding the uplink medium access control-control element successfully.

In some example embodiments, the computer readable medium may further include instructions stored thereon for causing the network device to further perform: configuring the downlink medium access control-control element.

In some example embodiments, the computer readable medium may further include instructions stored thereon for causing the network device to further perform: configuring a timer for the terminal device to retrigger the trigger event, the trigger event being retriggered upon expiry of the timer if the number of transmission reaches the transmission number and the terminal device without receiving, from the network device, the downlink medium access control-control element acknowledging the decoding of the uplink medium access control-control element before the timer expires.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for MAC-CE transmission according to the example embodiments of the present disclosure.

FIG. 2 shows an exemplary flow diagram for MAC-CE transmission according to the example embodiments of the present disclosure.

FIG. 3 shows a flow chart illustrating an example method 300 for MAC-CE transmission according to the example embodiments of the present disclosure.

FIG. 4 shows a flow chart illustrating an example method 400 for MAC-CE transmission according to the example embodiments of the present disclosure.

FIG. 5 shows a block diagram illustrating an example device 400 for MAC-CE transmission according to the example embodiments of the present disclosure.

FIG. 6 shows a block diagram illustrating an example device 600 for MAC-CE transmission according to the example embodiments of the present disclosure.

FIG. 7 shows a block diagram illustrating an example apparatus 700 for MAC-CE transmission according to the example embodiments of the present disclosure.

FIG. 8 shows a block diagram illustrating an example apparatus 800 for MAC-CE transmission according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution that a MAC-CE can be transmitted on any UL resources despite of the HARQ mode so as to avoid transmission latency and meanwhile the reliability of correctly decoding a critical MAC-CE can be ensured.

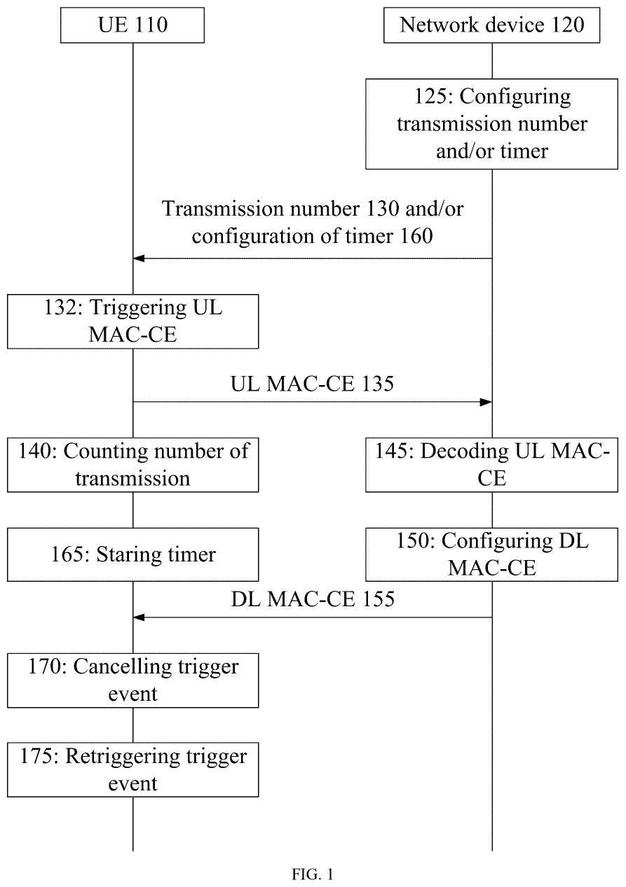

FIG. 1 shows an exemplary sequence diagram for MAC-CE transmission according to the example embodiments of the present disclosure. Referring to the FIG. 1, a UE 110 may represent any terminal device in a wireless communication network. A network device 120 may function as a BS in the wireless communication network and serving the UE 110. The wireless communication network may be e.g. a NTN, and the network device 120 may be located in a geosynchronous earth orbit (GEO) satellite or a non-GEO satellite, e.g. a medium earth orbit (MEO) satellite or a low earth orbit (LEO) satellite.

In an operation 125, the network device 120 may configure a transmission number 130 for the UE 110 to send a UL MAC-CE. The transmission number 130 may be common for a plurality of UL MAC-CEs. Alternatively, the transmission number 130 may be specific for a set of UL MAC-CEs. Alternatively, the transmission number 130 may be specific for one UL MAC-CE, e.g. a UL MAC-CE 135. The transmission number 130 may be a maximum number of transmission for the UE 110 to send the UL MAC-CE 135, which may represent any UL MAC-CE. If a number of transmission is less than the configured transmission number 130, the UE 110 may send the UL MAC-CE 135 in a HARQ process to the network device 120.

The network device 120 may transmit the transmission number 130 to the UE 110. Obtaining the configured transmission number 130, if a trigger event for the UL MAC-CE 135 occurs, in response to the trigger event, the UE 110 may in an operation 132 trigger the corresponding UL MAC-CE 135 and send, to the network device 120, the UL MAC-CE 135 in a HARQ process if the number of transmission is less than the configured transmission number 130. The transmission may be either an initial transmission of a transport block (TB) carrying the UL MAC-CE 135 or a retransmission of the TB carrying the UL MAC-CE 135. The UL MAC-CE 135 may be multiplexed/transmitted in the UL grant scheduled HARQ process of either HARQ of mode A or HARQ of mode B.

In an embodiment, as an option, if the UL MAC-CE 135 is sent in the HARQ process of mode A, in an operation 170 the UE 110 may cancel the trigger event after e.g. first transmission of the UL MAC-CE 135 and refrain from further sending the UL MAC-CE 135 if the trigger event is cancelled. Because mode A may support reception of UL retransmission grant based on UL decoding result, the reliability of correctly decoding the MAC-CE 135 can be ensured to some extent.

Alternatively, the UE 110 may refrain from canceling the trigger event even if the UL MAC-CE 135 is multiplexed/transmitted in the HARQ process of mode A. For example, the UE 110 may perform the following operations and/or cancel the trigger event based on other condition(s) regardless of HARQ mode A or HARQ mode B.

Alternatively, in some embodiments, the UE 110 may perform the following operations and/or cancel the trigger event based on other condition(s) if the UL MAC-CE 135 is sent in the HARQ process of mode B. HARQ mode B may support no UL retransmission and/or blind UL retransmission.

On the network side, if receiving the UL MAC-CE 135, in an operation 145 the network device 120 may decode the UL MAC-CE 135. If the network device 120 decodes the UL MAC-CE 135 successfully, the network device 120 may transmit, to the UE 110, a downlink (DL) MAC-CE 155 for acknowledging the decoding of the UL MAC-CE 135. The DL MAC-CE 155 may function as an acknowledgment (ACK) feedback for the UL MAC-CE 135.

If receiving the DL MAC-CE 155, in the operation 170, the UE 110 may cancel the trigger event and refrain from further sending the UL MAC-CE 135 if the trigger event is cancelled. In an embodiment, the ACK DL MAC-CE 155 may have a logical channel identifier (LCID) or an extended logical channel identifier (eLCID) specific for the ACK of the decoding of the UL MAC-CE 135. The LCID or the eLCID may be reserved for the UL MAC-CE 135. In an option, the LCID or the eLCID may be in a subheader of the ACK DL MAC-CE 155, and the ACK DL MAC-CE 155 may have no payload.

Alternatively, in an embodiment, the DL MAC-CE 155 may have a reserved bit specific for the ACK of the decoding of the UL MAC-CE 135. For example, the DL MAC-CE 155 may be an existing MAC-CE having at least one reserved bit, and one reserved bit may be used for the ACK of the decoding of the UL MAC-CE 135.

Alternatively or additionally, the ACK DL MAC-CE 155 may have a payload indicating the ACK of the decoding of the UL MAC-CE 135 by a bitmap. For example, the ACK DL MAC-CE 155 may have different bits for acknowledging the decoding of different UL MAC-CEs. For example, the third bit may be used for the ACK of the decoding of the UL MAC-CE 135, and the fifth bit may be used for the ACK of the decoding of another UL MAC-CE 135.

The mapping between the ACK DL MAC-CE 155 and the UL MAC-CE 135, as well as the bitmap of the ACK DL MAC-CE 155 may be configured by the network device 120 in an operation 150 and be transmitted to the UE 110 via a radio resource control (RRC) signaling, alternatively or additionally, may be pre-specified in a specification/standard.

Alternatively or additionally, after the first transmission of the UL MAC-CE 135, in an operation 140, the UE 110 may count a number of transmission of the UL MAC-CE 135, and may cancelling the trigger event if the number of transmission reaches the configured transmission number 130.

In an embodiment, the UE 110 may count the number of transmission based on a number of initial transmission and retransmission of at least one TB carrying the UL MAC-CE 135. For example, no matter the UL MAC-CE 135 is initially transmitted on a TB, retransmitted on the TB, or initially transmitted and retransmitted on another TB, the UE 110 will count as an increment of the number of transmission.

Alternatively, in an embodiment, the UE 110 may count the number of transmission based on the number of initial transmission of at least one TB carrying the UL MAC-CE 135. For example, after the initial transmission on a TB, the retransmission on the TB will not be counted. The UE 110 will count as an increment of the number of transmission if the UL MAC-CE 135 is initially transmitted on another TB. In this case, the number of transmission may be the number of transmitted TBs carrying the UL MAC-CE 135.

On the network side, in the operation 125, the UE 110 may also configure a timer 160 for the UE 110 to retrigger the trigger event. The timer 160 may relate to a duration allowing the network device 120 to confirm the decoding of the UL MAC-CE 135. The configuration of the timer 160 may include a length of the timer. As an option, the configuration of the timer 160 may further include starting timing of the timer 160. Alternatively, the starting timing of the timer 160 may be pre-specified in specification or standard. Receiving the configuration of the timer 160, the UE 110 may use the timer 160 to retrigger the trigger event if the number of transmission reaches the transmission number 130 and the UE 110 has not received the ACK DL MAC-CE 155 before the timer 160 expires.

With the configured timer 160, in an operation 165, the UE 110 may start the timer 160. In an embodiment, the UE 110 may start the timer 160 at a last retransmission of the UL MAC-CE 135. In this case, the length of the timer 160 may be at least one round trip time (RTT) between the UE 110 and the network device 120. Alternatively, in an embodiment, the UE 110 may start the timer 160 at an initial transmission of the UL MAC-CE 135. In this case, the length of the timer 160 may be at least one RTT between the UE 110 and the network device 120 plus an estimated duration of retransmission(s) of the UL MAC-CE 135.

In an operation 175, the UE 110 may retrigger the trigger event upon expiry of the timer 160 if the number of transmission reaches the configured transmission number 130 and without receiving, from the network device 120, the ACK DL MAC-CE 155 acknowledging the decoding of the UL MAC-CE 135 before the timer 160 expires. By retriggering the trigger event, the UE 110 may repeat the sending of the UL MAC-CE 135 such that the reliability of successfully decoding the UL MAC-CE 135 can be ensured

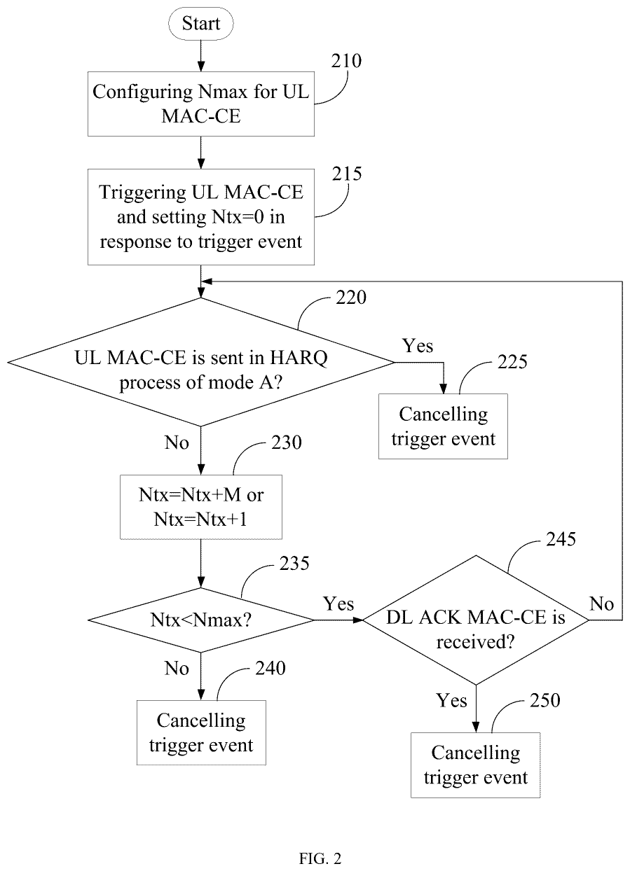

FIG. 2 shows an exemplary flow diagram for MAC-CE transmission according to the example embodiments of the present disclosure. Operations in the FIG. 2 will be briefly described if corresponding operations shown in the FIG. 1 have been described.

After a start of the flow, in an operation 210 the network device 120 may configure the maximum number of transmission, denoted as Nmax, for a UL MAC-CE. The Nmax may be e.g. the transmission number 130, and the UL MAC-CE may be e.g. the UL MAC-CE 135.

In an operation 215, in response to the trigger event for the UL MAC-CE 135, the UE 110 may trigger the corresponding UL MAC-CE 135 and set the number of transmission, denoted as Ntx, to be 0 and start the transmission of the UL MAC-CE 135 in a HARQ process.

As an option, in an operation 220, if the UL MAC-CE 135 is multiplexed/sent in the HARQ process of mode A (“Yes” prong of the operation 220), in an operation 225, the UE 110 may cancel the trigger event and refrain from further sending the UL MAC-CE 135 if the trigger event is cancelled. If the UL MAC-CE 135 is multiplexed/sent in the HARQ process of mode B (“No” prong of the operation 220), the UE 110 may continue the following operations.

Alternatively, the operation 220 may be omitted, and in this case the UE 110 may perform the flow despite the HARQ mode.

In an operation 230, the UE 110 may count the Ntx. In an embodiment, the UE 110 may count the Ntx if a TB carrying the UL MAC-CE 135 is transmitted, regardless whether the UL MAC-CE 135 is initially transmitted on a TB, retransmitted on the TB or transmitted on other TB(s). If the HARQ process is set with a number of times for transmission, denoted as M, where the UL MAC-CE 135 will be transmitted M times, the Ntx may increase by M. For example, in a case where the UL MAC-CE 135 is multiplexed/transmitted in the HARQ process of mode B, if mode B supports blind retransmission, M may be equal to the number of times for the initial transmission and the following blind retransmission, and if mode B supports no UL retransmission, M will be one.

Alternatively in an embodiment, the UE 110 may count the Ntx as the number of initial transmissions of different TBs carrying the UL MAC-CE 135. In this case the Ntx will increase by one regardless whether the retransmission is supported by the HARQ mode.

In an operation 235, in a case where the Ntx has not reached the Nmax (“Yes” prong of the operation 235), if in an operation 245 the UE 110 receives a DL ACK MAC-CE e.g. the ACK DL MAC-CE 155 acknowledging the decoding of the UL MAC-CE 135 (“Yes” prong of the operation 245), in an operation 250, the UE 110 may cancel the trigger event and refrain from further sending the UL MAC-CE 135 if the trigger event is cancelled. If in the operation 245 the UE 110 has not received the ACK DL MAC-CE 155 (“No” prong of the operation 245), the UE 110 may continue the flow from the operation 220.

In the operation 235, if the Ntx reaches the Nmax (“No” prong of the operation 235), in an operation 240, the UE 110 may cancel the trigger event. After the operation 240 where the Ntx has reached the Nmax, if the UE 110 has not received the ACK DL MAC-CE 155 before e.g. the timer 160 expires, the UE 110 may retrigger the trigger event upon expiry of the timer 160. In this case, the flow may repeat from the operation 215.

It may be appreciated that the above embodiments may apply for any UL MAC-CE. Because there is no limitation on logical channel prioritization (LCP) on UL MAC-CE, a UL MAC-CE can be transmitted on any UL resources despite of the HARQ mode such that the UL MAC-CE transmission opportunities can be fully utilized and transmission latency can be avoided. Meanwhile the reliability of successfully decoding a UL MAC-CE can be ensured. The embodiments according to the present disclosure can result in more advantageous effects for a critical UL MAC-CE.

For example, for a UL MAC-CE reporting timing advance (TA), which may assist UL scheduling in the NTN and may be referred to as a TA report MAC-CE, if the TA report MAC-CE cannot be decoded by the network side successfully, the system performance will be severely impacted. The embodiments according to the present disclosure may be adaptive to the UL grant scheduled HARQ process despite the HARQ mode, and thus the reliability of successfully decoding a UL MAC-CE e.g. the TA report MAC-CE, can be achieved.

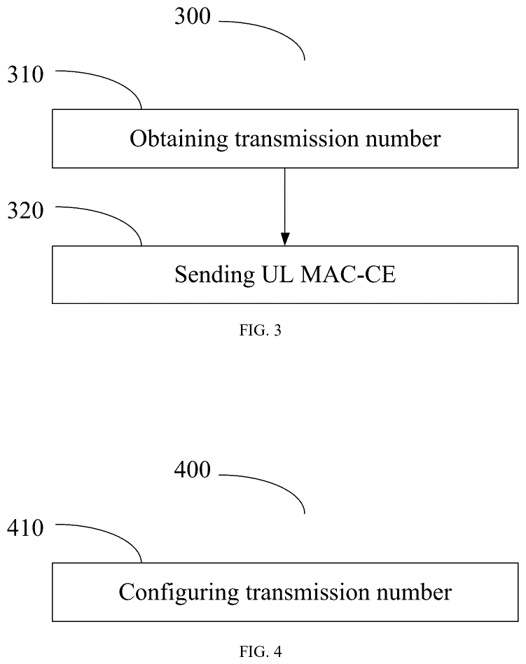

FIG. 3 shows a flow chart illustrating an example method 300 for MAC-CE transmission according to the example embodiments of the present disclosure. The example method 300 may be performed for example at a terminal device such as the UE 110.

Referring to the FIG. 3, the example method 200 may include an operation 310 of obtaining, a transmission number configured by a network device for sending a UL MAC-CE: and an operation 320 of sending, to the network device, the UL MAC-CE in a HARQ process if a number of transmission is less than the configured transmission number, in response to a trigger event for the UL MAC-CE.

Details of the operation 310 have been described in the above descriptions with respect to at least the transmission number 130 and the Nmax, and repetitive descriptions thereof are omitted here.

Details of the operation 320 have been described in the above descriptions with respect to at least the UL MAC-CE 135, and repetitive descriptions thereof are omitted here.

In an embodiment, the example method 300 may further include an operation of cancelling the trigger event if the UL MAC-CE is sent in the HARQ process of mode A and refraining from further sending the UL MAC-CE. The more details have been described in the above descriptions with respect to at least the operation 170 and the operations 220 and 225, and repetitive descriptions thereof are omitted here.

In an embodiment, the example method 300 may further include an operation of cancelling the trigger event if receiving, from the network device, a DL MAC-CE acknowledging decoding of the UL MAC-CE and refraining from further sending the UL MAC-CE. The more details have been described in the above descriptions with respect to at least the DL MAC-CE 155, the operation 170 and the operations 245 and 250, and repetitive descriptions thereof are omitted here.

In an embodiment, the acknowledging DL MAC-CE may have a LCID or an eLCID specific for the ACK of the decoding of the UL MAC-CE. The more details have been described in the above descriptions with respect to at least the DL MAC-CE 155, and repetitive descriptions thereof are omitted here.

In an embodiment, the LCID or the eLCID may be in a subheader of the acknowledging DL MAC-CE, and the acknowledging DL MAC-CE may be without a payload. The more details have been described in the above descriptions with respect to at least the DL MAC-CE 155, and repetitive descriptions thereof are omitted here.

In an embodiment, the DL MAC-CE may have a reserved bit specific for the ACK of the decoding of the UL MAC-CE. The more details have been described in the above descriptions with respect to at least the DL MAC-CE 155, and repetitive descriptions thereof are omitted here.

In an embodiment, the acknowledging DL MAC-CE may have a payload indicating the ACK of decoding the UL MAC-CE by a bitmap. The more details have been described in the above descriptions with respect to at least the DL MAC-CE 155, and repetitive descriptions thereof are omitted here.

In an embodiment, the example method 300 may further include an operation of cancelling the trigger event if the number of transmission reaches the configured transmission number. The more details have been described in the above descriptions with respect to at least the operation 170 and the operations 235 and 240, and repetitive descriptions thereof are omitted here.

In an embodiment, the number of transmission may be counted based on a number of initial transmission and retransmission of at least one TB carrying the UL MAC-CE. The more details have been described in the above descriptions with respect to at least the operation 140 and the operation 230, and repetitive descriptions thereof are omitted here.

In an embodiment, the number of transmission may be counted based on a number of initial transmission of at least one TB carrying the UL MAC-CE. The more details have been described in the above descriptions with respect to at least the operation 140 and the operation 230, and repetitive descriptions thereof are omitted here.

In an embodiment, the example method 300 may further include an operation of starting a timer configured by the network device for retriggering the trigger event, the more details of which have been described in the above descriptions with respect to at least the operation 165, and repetitive descriptions thereof are omitted here: and an operation of retriggering the trigger event upon expiry of the timer if the number of transmission reaches the configured transmission number and without receiving, from the network device, a DL MAC-CE acknowledging the decoding of the UL MAC-CE before the timer expires, the more details of which have been described in the above descriptions with respect to at least the operation 175 and the operation 255, and repetitive descriptions thereof are omitted here.

In an embodiment, the timer may be started at a last retransmission of the UL MAC-CE. The more details have been described in the above descriptions with respect to at least the operation 165, and repetitive descriptions thereof are omitted here.

In an embodiment, the timer may be started at an initial transmission of the UL MAC-CE. The more details have been described in the above descriptions with respect to at least the operation 165, and repetitive descriptions thereof are omitted here.

In an embodiment, the UL MAC-CE may be sent in the HARQ process of mode B. The more details have been described in the above descriptions with respect to at least the operation 220, and repetitive descriptions thereof are omitted here.

In an embodiment, the transmission number may be common for a plurality of UL MAC-CEs. The more details have been described in the above descriptions with respect to at least the transmission number 130, and repetitive descriptions thereof are omitted here.

In an embodiment, the transmission number may be specific to the UL MAC-CE. The more details have been described in the above descriptions with respect to at least the transmission number 130, and repetitive descriptions thereof are omitted here.

FIG. 4 shows a flow chart illustrating an example method 400 for MAC-CE transmission according to the example embodiments of the present disclosure. The example method 400 may be performed for example at a network device such as the network device 120.

Referring to the FIG. 4, the example method 400 may include an operation 410 of configuring a transmission number for a terminal device to send a UL MAC-CE, wherein the UL MAC-CE may be sent to the network device in a HARQ process if a number of transmission is less than the configured transmission number, in response to a trigger event for the UL MAC-CE.

Details of the operation 410 have been described in the above descriptions with respect to at least the operation 125, the transmission number 130, the operation 210 and the Nmax, and repetitive descriptions thereof are omitted here.

In an embodiment, the example method 400 may further include an operation of transmitting, to the terminal device, a DL MAC-CE for acknowledging decoding of the UL MAC-CE if decoding the UL MAC-CE successfully. The more details have been described in the above descriptions with respect to at least the DL MAC-CE 155, and repetitive descriptions thereof are omitted here.

In an embodiment, the example method 400 may further include an operation of configuring the DL MAC-CE. The more details have been described in the above descriptions with respect to at least the operation 150, and repetitive descriptions thereof are omitted here.

In an embodiment, the example method 400 may further include an operation of configuring a timer for the terminal device to retrigger the trigger event, the trigger event being retriggered upon expiry of the timer if the number of transmission reaches the transmission number and the terminal device without receiving, from the network device, the DL MAC-CE acknowledging the decoding of the UL MAC-CE before the timer expires. The more details have been described in the above descriptions with respect to at least the timer 160 and the operation 170, and the operation 255, and repetitive descriptions thereof are omitted here.

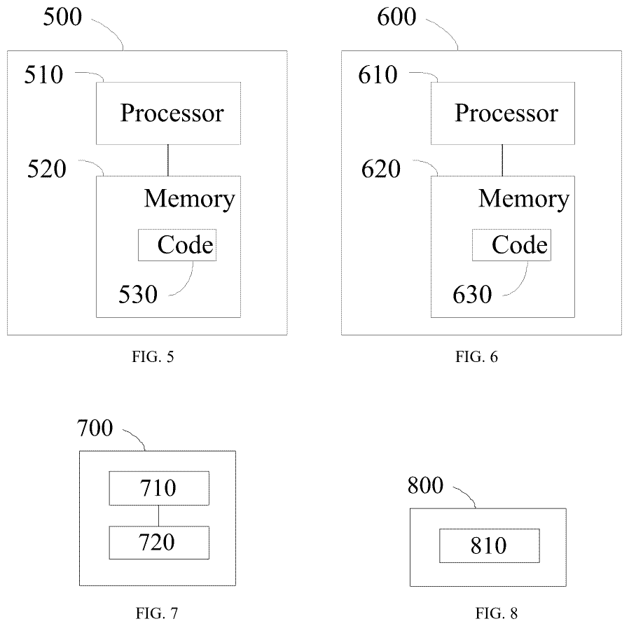

FIG. 5 shows a block diagram illustrating an example device 400 for MAC-CE transmission according to the example embodiments of the present disclosure. The device, for example, may be at least part of a terminal device such as the UE 110 in the above examples.

As shown in the FIG. 5, the example device 500 may include at least one processor 510 and at least one memory 520 that may include computer program code 530. The at least one memory 520 and the computer program code 530 may be configured to, with the at least one processor 510, cause the device 500 at least to perform the example method 300 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example device 500 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 500.

FIG. 6 shows a block diagram illustrating an example device 600 for MAC-CE transmission according to the example embodiments of the present disclosure. The device, for example, may be at least part of a network device such as the network device 120 in the above examples.

As shown in the FIG. 6, the example device 600 may include at least one processor 610 and at least one memory 620 that may include computer program code 630. The at least one memory 620 and the computer program code 630 may be configured to, with the at least one processor 610, cause the device 600 at least to perform the example method 400 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 120 is not limited to the above example device 600.

FIG. 7 shows a block diagram illustrating an example apparatus 700 for MAC-CE transmission according to the example embodiments of the present disclosure. The apparatus, for example, may be at least part of a terminal device such as the UE 110 in the above examples.

As shown in FIG. 7, the example apparatus 700 may include means 710 for performing the operation 310 of the example method 300, and means 720 for performing the operation 320 of the example method 400. In one or more another example embodiments, at least one I/O interface, at least one antenna element, and the like may also be included in the example apparatus 700.

In some example embodiments, examples of means in the example apparatus 700 may include circuitries. For example, an example of means 710 may include a circuitry configured to perform the operation 310 of the example method 300, and an example of means 720 may include a circuitry configured to perform the operation 320 of the example method 300. In some example embodiments, examples of means may also include software modules and any other suitable function entities.

FIG. 8 shows a block diagram illustrating an example apparatus 800 for MAC-CE transmission according to the example embodiments of the present disclosure. The apparatus, for example, may be at least part of a network device such as the network device 120 in the above examples.

As shown in FIG. 8, the example apparatus 800 may include means 810 for performing the operation 410 of the example method 400. In one or more another example embodiments, at least one I/O interface, at least one antenna element, and the like may also be included in the example apparatus 800.

In some example embodiments, examples of means in the example apparatus 800 may include circuitries. For example, an example of means 810 may include a circuitry configured to perform the operation 410 of the example method 400. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry): (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions): and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense: that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms: furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
ACK acknowledgment
BS base station
DL downlink
eLCID extended logical channel identifier
GEO geosynchronous earth orbit
HARQ hybrid automatic repeat request
LCID logical channel identifier
LCP logical channel prioritization
LEO low earth orbit
MAC-CE medium access control-control element
MEO medium earth orbit
NTN non-terrestrial network
RRC radio resource control
RTT round trip time
TA timing advance
TB transport block
UE user equipment
UL uplink

1. A terminal device, comprising:
at least one processor; and
at least one memory comprising computer program code, the at least one memory and the computer program code being configured to, with the at least one processor, cause the terminal device to perform:
obtaining, a transmission number configured by a network device for sending an uplink medium access control-control element; and
sending, to the network device, the uplink medium access control-control element in a hybrid automatic repeat request process if a number of transmission is less than the configured transmission number, in response to a trigger event for the uplink medium access control-control element.

2.-44. (canceled)
